(19) United States
(12) Patent Application Publication
(10) Pub. No.: US 2026/0300880 A1
(43) Pub. Date: Oct. 1, 2026

(54) METHOD AND APPARATUS FOR PROCESSING LOG, DEVICE, MEDIUM, AND PRODUCT

(71) Applicant: Beijing Zitiao Network Technology Co., Ltd., Beijing (CN)

(72) Inventor: Ka LU, Beijing (CN)

(21) Appl. No.: 19/630,436

(22) Filed: Mar. 27, 2026

(30) Foreign Application Priority Data
Mar. 28, 2025 (CN) 202510382200.6

(51) Int. Cl. G06Q 10/0635

(52) U.S. Cl. CPC G06Q 10/0635

(57) ABSTRACT

Embodiments of the present disclosure relate to a method and an apparatus for processing a log, a device, a medium, and a product. The method includes determining a plurality of logs related to running of an application. The method further includes identifying a target log having a risky behavior among the plurality of logs. The method further includes obtaining contextual information of the target log from the plurality of logs, the contextual information including the target log. The method further includes attributing the target log to determine a risk issue of the target log based on a plurality of rules for the risky behavior and the contextual information.

### CROSS-REFERENCE TO RELATED APPLICATION

This application claims priority to Chinese Application No. 202510382200.6 filed on Mar. 28, 2025, the disclosure of which is incorporated herein by reference in its entirety.

### FIELD

Embodiments of the present disclosure generally relate to the field of the Internet, and in particular, to a method and an apparatus for processing a log, a device, a medium, and a product.

### BACKGROUND

In today's modern information society, Internet technologies are developing more and more vigorously. Users often involve permission for a wide variety of application activities in the process of using various software applications. For example, when a user uses a software application on a smart phone, the software application may collect some information after obtaining the user's permission, such as device hardware information of the smart phone, system information of the device, and information in other applications. Moreover, with the development of Internet technologies, the collection, storage, and sharing of such information have become more and more common.

However, in the process of users using software applications, because the software applications are usually granted the usage permission, the abuse of these permissions may lead some software applications to collect device and user-related information without limit, resulting in the leakage of users' data privacy and the emergence of information security vulnerabilities. Therefore, the protection of data privacy and the reinforcement of information security involved in the process of users using software applications are increasingly worth further studying.

### SUMMARY

Embodiments of the present disclosure provide a method and an apparatus for processing a log, a device, a medium, and a product.

According to a first aspect of the present disclosure, there is provided a method for processing a log. The method includes determining a plurality of logs related to running of an application. The method further includes identifying a target log having a risky behavior among the plurality of logs. The method further includes obtaining contextual information of the target log from the plurality of logs, the contextual information including the target log. The method further includes attributing the target log to determine a risk issue of the target log based on a plurality of rules for the risky behavior and the contextual information.

In a second aspect of the present disclosure, there is provided an apparatus for processing a log. The apparatus includes a plurality of logs determination module configured to determine a plurality of logs related to running of an application; a target log identification module configured to identify a target log having a risky behavior among the plurality of logs; a contextual information obtaining module configured to obtain contextual information of the target log from the plurality of logs, the contextual information including the target log; and an attribution module configured to attribute the target log to determine a risk issue of the target log based on a plurality of rules for the risky behavior and the contextual information.

In a third aspect of the present disclosure, there is provided an electronic device. The electronic device includes at least one processor; and a memory device for storing at least one program, where the at least one program, when executed by the at least one processor, causes the at least one processor to implement the method of the first aspect of the present disclosure.

In a fourth aspect of the present disclosure, there is provided a computer-readable storage medium having a computer program stored thereon, the program, when executed by a processor, implementing the method of the first aspect of the present disclosure.

In a fifth aspect of the present disclosure, there is provided a computer program product. The computer program product includes a computer program, where the computer program, when executed by a processor, implements the method of the first aspect of the present disclosure.

It should be understood that the content described in this Summary is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other objects, features, and advantages of the present disclosure will become more apparent by describing the exemplary embodiments of the present disclosure in more detail in conjunction with the drawings, in which the same reference numbers generally represent the same components in the exemplary embodiments of the present disclosure.

FIG. 1 illustrates a schematic diagram of an example environment in which the device and/or the method of some embodiments of the present disclosure may be implemented;

FIG. 2 illustrates a schematic diagram of an example method for processing a log according to some embodiments of the present disclosure;

FIG. 3 illustrates a schematic diagram of an example of a flowchart for processing a log according to some embodiments of the present disclosure;

FIG. 4 illustrates a schematic diagram of an example of creating rules for processing a log according to some embodiments of the present disclosure;

FIG. 5 illustrates a schematic diagram of an example of detailed information of rules for processing a log according to some embodiments of the present disclosure;

FIG. 6 illustrates a schematic diagram of an example of a data mining policy for processing a log according to some embodiments of the present disclosure;

FIG. 7 illustrates a schematic diagram of an example of information of a work order for processing a log according to some embodiments of the present disclosure;

FIG. 8 illustrates a schematic diagram of an example of re-attributing a historical log according to some embodiments of the present disclosure;

FIG. 9 illustrates a schematic block diagram of an apparatus for processing a log according to some embodiments of the present disclosure; and

FIG. 10 illustrates a schematic block diagram of an example device suitable for implementing multiple embodiments of the present disclosure.

Throughout the drawings, the same or corresponding reference numbers represent the same or corresponding parts.

### DETAILED DESCRIPTION OF EMBODIMENTS

It should be understood that the data involved in the technical solution (including but not limited to the data itself, acquisition or use of the data) should comply with requirements of corresponding laws, regulations, and related provisions.

It should be understood that before using the technical solutions disclosed in the embodiments of the present disclosure, the user shall be informed of the type, range of use, use scenarios, etc., of personal information involved in the present disclosure in an appropriate manner and the authorization of the user shall be obtained in accordance with relevant laws and regulations.

For example, when receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It should be understood that the above process of notifying and obtaining user authorization is only illustrative and does not limit the implementations of the present disclosure, and other methods that satisfy the relevant laws and regulations may also be applied to the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "based at least in part on". The term "an embodiment" or "the embodiment" should be understood as "at least one embodiment". The terms "first", "second", etc. may refer to different or same objects. Other explicit and implicit definitions may be included below.

In modern information society, data privacy and information security become increasingly important. With the rapid development of Internet technologies and the continuous improvement of data processing capabilities, the collection, storage, processing, and sharing of personal information have become increasingly common. In this context, the management and monitoring of privacy risks of applications has become a crucial issue. Traditional privacy risk management mainly relies on stack analysis and manual log review, which requires a lot of manpower.

However, with traditional stack analysis and manual log review, after investing a lot of manpower, it is still difficult to detect privacy risks of applications in real time and capture the full picture of the risks. For example, stack analysis is a method of locating errors and risks by examining the stack information of an application. This method relies on the developer's in-depth understanding of the code and stack structure. However, as the complexity of applications increases, the stack information becomes more voluminous and complex, and the difficulty and workload of analysis increase accordingly. In addition, stack analysis may usually only provide limited contextual information, making it difficult to fully capture the full picture of privacy risk behavior. For another example, manual log review is a method of locating problems and risks by analyzing system-generated log files. Manual review requires a lot of manpower and time, and is prone to be limited by the reviewer's expertise and experience. In the face of massive log data, the efficiency and accuracy of manual review are difficult to be guaranteed. At the same time, it is also difficult to detect and respond to privacy risk logs in real time through manual review. As a result, the user experience is significantly reduced.

To solve at least the above and other potential problems, embodiments of the present disclosure propose a method for processing a log. In this method, a computing device may first determine a plurality of logs related to the running of an application. In addition, after the plurality of logs are determined, a target log having a risky behavior is identified among the plurality of logs. Next, the computing device obtains contextual information of the target log from the plurality of logs, the contextual information including the target log. Finally, the computing device attributes the target log to determine a risk issue of the target log based on a plurality of rules for the risky behavior and the obtained contextual information. Through this method, by utilizing the plurality of logs related to the running of the application and in combination with the plurality of rules related to the plurality of logs, automated attribution of the risky behavior in the logs may be realized, which greatly reduces resource consumption, improves the efficiency of processing the risky behavior in the logs, and improves the user experience.

It should be understood that the present disclosure is only illustrated in combination with related embodiments, and the protection scope of the present disclosure is not limited by the related embodiments. Any technical solution in other disclosures falling within the protection scope of the present disclosure should be protected.

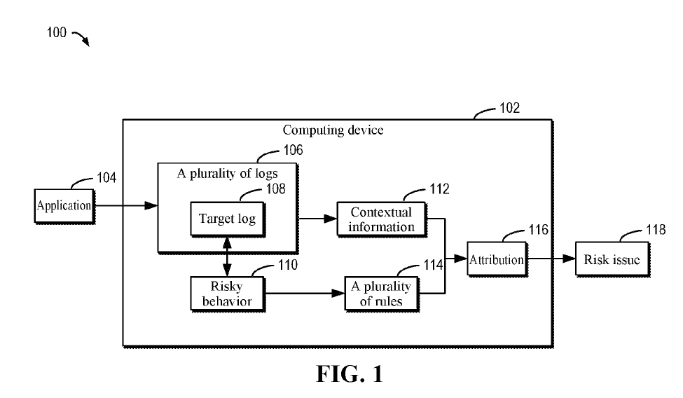

The embodiments of the present disclosure will be further described in detail below in combination with the drawings. FIG. 1 shows an example environment in which the device and/or the method of the embodiments of the present disclosure may be implemented. In the environment 100, a computing device 102 may obtain data information of an application 104. Additionally, the application 104 may run on the computing device 102, and the computing device 102 may be used to perform processing on related data in the application 104, for example, to process log information generated when the application 104 is running.

Examples of the computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a small computer, a mainframe computer, a distributed computing environment including any of the above systems or devices, etc.

As shown in FIG. 1, the computing device 102 first determines a plurality of logs related to the running of the application 104. The plurality of logs 106 are information related to the running of the application, and for example, the plurality of logs 106 may include running log information related to the running of the application, code debugging information, stack-related information, and the like.

Subsequently, the computing device 102 may identify a target log 108 having a risky behavior 110 among the plurality of logs 106. It should be understood that the target log 108 is one of the plurality of logs 106 that has the risky behavior, and the plurality of logs 106 may also include other logs that have a risky behavior. Moreover, the risky behavior 110 may also be one of various risky behaviors.

Next, the computing device 102 obtains contextual information 112 of the target log 108 from the plurality of logs 106, the contextual information 112 including the target log 108. For example, the contextual information includes 100 or 200 logs around the target log. It should be understood that the number of logs in the contextual information may be defined by the user, which is not limited in the present application.

Finally, the computing device 102 may perform matching based on a plurality of rules 114 for the risky behavior 110 and the contextual information 112 to attribute 116 the target log 108, thereby determining a risk issue 118 of the target log 108. Additionally, in addition to being instructed to determine the risk issue 118 of the target log 108, the attribution 116 may also be instructed to determine the impact scope of the risk issue 118.

In addition, after the attribution 116 of the target log 108 is completed, the determined risk issue 118 and the impact scope may also be analyzed, so as to generate an analysis report for the risky behavior and present the report to the user in a visual manner, which is convenient for the user to view and perform further analysis.

Through this method, by utilizing the plurality of logs during the running of the application and in combination with the plurality of rules related to the plurality of logs, automated attribution of the risky behavior in the logs may be realized, and an analysis report for the risk issue may be further generated, which greatly reduces manpower consumption, improves the efficiency of processing the risky behavior in the logs, and improves the user experience.

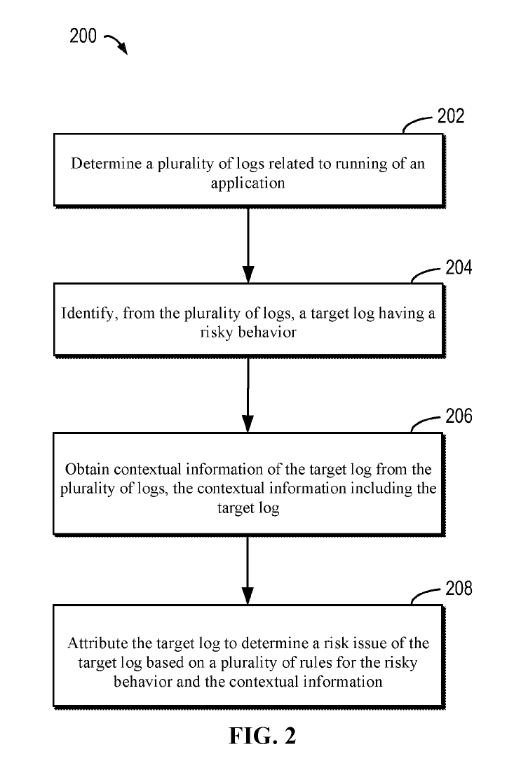

The schematic diagram of the example environment in which the device and/or the method of some embodiments of the present disclosure may be implemented is described above in conjunction with FIG. 1, and the schematic diagram of the example method for processing a log according to some embodiments of the present disclosure is described below in conjunction with FIG. 2. The example method may be performed by the computing device 102 in FIG. 1 or any suitable computing device.

As shown in FIG. 2, in an example method 200, at block 202, a plurality of logs related to running of an application are determined. In order to analyze the risks in the running of a program or an application, it is usually necessary to obtain logs that record the work or running information of the program or the application.

Before determining the plurality of logs 106, the computing device 102 first obtains a plurality of initial logs, and then performs pre-processing on the plurality of initial logs to obtain the plurality of logs 106. The plurality of initial logs include information related to the running of the application, and for example, the plurality of initial logs include information related to the running of the application, such as runtime information, code debugging information, and stack information of the application. The runtime information includes the user login status, the front-end and back-end status of the application, etc.

In one example, the plurality of logs 106 may be obtained by performing format conversion on the plurality of initial logs. For example, the format conversion may be performed on timestamp information of the plurality of initial logs. If the timestamp information is in an unreadable form of "1294847574", the timestamp information may be converted into a readable form of "2024-05-06" through the format conversion.

In another example, the plurality of logs 106 may be obtained by performing data cleaning on the plurality of initial logs. Since the plurality of initial logs may include dirty data, and the dirty data is generally inaccurate, incomplete, or invalid data caused by various reasons, such data cannot bring actual application value, but instead occupies storage space and wastes resources, and may even lead to serious business problems.

However, the dirty data does not necessarily include risky behaviors, so built-in rules are required to filter the dirty data to prevent the dirty data from being misidentified as risky behaviors in the future. In one example, the black and gray industry data may be filtered out by setting built-in rules. In another example, additional data generated by abnormal running of the application due to user tampering may also be filtered by setting built-in rules. In yet another example, non-critical logs may also be filtered out by setting built-in rules, such as filtering out non-critical logs such as system logs, script logs, and user's own logs to improve the efficiency in the data processing process.

In yet another example, the plurality of logs 106 may be obtained by performing time synchronization on the plurality of initial logs. For example, since the application 104 has been released all over the world, users of the application 104 may come from all over the world, and there are time differences between different regions. In this case, by performing time synchronization on the time in the plurality of initial logs, the time in different regions may be synchronized to the time in the same time zone, which is convenient for subsequent data processing.

Additionally, the processing of the plurality of initial logs may include at least one of the above three pre-processing steps, that is, the plurality of initial logs may also be processed by combining two of the above three pre-processing steps or all three pre-processing steps, thereby obtaining the plurality of logs 106. It should be understood that at least one of the above three pre-processing steps may be determined according to actual needs, which is not limited in the present application.

In some embodiments, after the plurality of logs 106 are determined, the plurality of logs 106 are stored in a database dedicated to storing logs, so as to facilitate subsequent repeated retrieval for attribution.

In addition, the computing device 102 may further obtain a plurality of rules for processing the plurality of logs. In some embodiments, the plurality of rules 114 are obtained by analyzing and summarizing historical logs. In some embodiments, after determining the plurality of logs 106, the computing device 102 further creates the plurality of rules 114 for the plurality of logs 106 based on some logs of the plurality of obtained logs 106. Additionally, the plurality of created rules 114 may also be stored in a risk rule base dedicated to storing rules, and the risk rule base may be updated by adding new rules or deleting old rules.

The plurality of rules 114 include an access control rule, a data leakage identification rule, or an abnormal behavior detection rule. In one example, the access control rule may be a rule that controls an application to access specific information, and for example, the access control rule may be a rule that controls an application to read geographic location information in a specific region, such as controlling an application to read geographic location information in country A. In another example, the data leakage identification rule may be a rule that controls an application to read specific data, and for example, the data leakage identification rule may be a rule that controls an application to read clipboard information to prevent user data from being leaked. In yet another example, the abnormal behavior detection rule may be a rule that controls an application to use device hardware, and for example, the abnormal behavior detection rule may be a rule that controls an application to use a smartphone camera.

Then, at block 204, a target log having a risky behavior is identified among the plurality of logs.

After the plurality of logs 106 are determined, the computing device 102 may further identify the target log 108 among the plurality of logs 106. For example, the behaviors in the plurality of logs 106 may be traversed to determine the risky behavior with risks in the plurality of logs 106, and then the log corresponding to the risky behavior is determined as the target log 108.

In some embodiments, the log may be identified as the target log 108 by adding a link tracking identifier to the log corresponding to the risky behavior. Additionally, when the plurality of logs 106 include a plurality of target logs having risky behaviors, the plurality of target logs may be identified by adding a plurality of different link tracking identifiers to the plurality of target logs.

Next, at block 206, contextual information of the target log is obtained from the plurality of logs, the contextual information including the target log.

After identifying the target log 108, the computing device 102 further obtains the contextual information 112 of the target log 108, and the contextual information 112 may be used and combined with the plurality of rules 114 to attribute 116 the target log 108.

The contextual information 112 is a predetermined number of logs including the target log 108, and the computing device 102 may select the predetermined number of logs including the target log 108 from the plurality of logs 106 and determine the predetermined number of logs as the contextual information 112. In one example, the computing device 102 selects, in chronological order, the first 50 logs and the last 50 logs of the target log 108, 101 logs in total, as the contextual information 112. In another example, the computing device 102 selects the first 30 logs of the target log 108, 31 logs in total, as the contextual information 112 in chronological order. In yet another example, the computing device 102 selects the last 50 logs of the target log 108, 51 logs in total, as the contextual information 112 in chronological order.

Finally, at block 208, the target log is attributed to determine a risk issue of the target log based on a plurality of rules for the risky behavior and the contextual information.

After determining the contextual information 112 and the plurality of rules 114, the computing device 102 further attributes 116 the target log based on the contextual information 112 and the plurality of rules 114, to determine the risk issue 118 of the target log 108. It should be noted that, in addition to being instructed to determine the risk issue 118 of the target log 108, the attribution 116 may also be instructed to determine the impact scope of the risk issue 118. In one example, the impact scope of the risk issue 118 may indicate the severity of the risk issue 118. The greater the impact scope of the risk issue 118, the higher the severity of the risk issue 118.

In some embodiments, since a large amount of data of the plurality of logs 106 needs to be processed during the attribution process, a message queue may be used to improve the efficiency of processing the plurality of logs 106 during the attribution process. Additionally, the Kafka message queue may be used to process the plurality of logs 106. It should be understood that any other method may be used to improve the efficiency of processing the plurality of logs 106, which is not limited in the present application.

In some embodiments, by matching the contextual information 112 with contents of a rule among the plurality of rules 114, when a rule in the plurality of rules 114 that matches the contextual information is present, the rule may be determined as a target rule, and then the computing device 102 may use the determined target rule to attribute 116 the target log 108.

In some embodiments, the matching of the contextual information 112 with the contents of a rule among the plurality of rules 114 is performed through a regular expression. For example, when the data scale of the contextual information 112 is relatively small, the key information in the contents of a rule among the plurality of rules 114 may be written into the regular expression, and the regular expression may be used to match the contextual information 112. When the regular expression may match the result, the rule is determined as the target rule.

Additionally, when the data scale of the contextual information 112 is relatively large, the matching efficiency of the regular expression may decline. At this time, program code may be used to further combine the regular expression to improve the efficiency and accuracy of matching. It should be noted that the program code may be Python, C, C#, etc., or any other language code that may implement the matching process, which is not limited in the present application.

In some embodiments, when a rule in the plurality of rules 114 that matches the contextual information is absent, the computing device 102 may generate a target rule for the risky behavior 110 based on the contextual information 112. Additionally, the computing device 102 may add the generated target rule to the plurality of rules 114 and update the plurality of rules 114.

After the plurality of rules 114 are updated, the plurality of updated rules 114 may be re-used to attribute the un-attributed logs. Additionally, the computing device 102 may further determine a plurality of historical logs having risky behaviors within a predetermined time period, for example, may determine a plurality of historical logs within 24 hours before the target time node, and then re-attribute the plurality of historical logs based on the plurality of updated rules 114. In one example, the computing device 102 obtains 100 historical logs at 3:00 pm on May 6, 2024 and within 24 hours before, and re-attributes the plurality of historical logs based on the plurality of updated rules 114.

In some embodiments, after the attribution 116 of the target log 108 is completed, the computing device 102 may further generate a business credential for the target log 108. For ease of understanding, the business credential may also be referred to as a work order. The work order includes basic information such as a business work order name, a work order number, a work order type, etc.

In some embodiments, after the attribution 116 of the target log 108 is completed, the computing device 102 may further generate an analysis result of the risk issue corresponding to the target log 108 in combination with the contextual information 112. The risk issue includes the risky behavior 110 and the impact scope of the risky behavior. Subsequently, the analysis result is presented to the user in a visual manner, for example, an analysis report of the analysis result is generated and given to the user.

Through this method, by utilizing the plurality of logs related to the runtime information, code debugging, and stack of the application, and in combination with the plurality of rules related to the plurality of logs, automated attribution of the risky behavior in the logs may be realized, and an analysis report for the risk issue may be further generated, which greatly reduces manpower consumption, improves the efficiency of processing the risky behavior in the logs, and improves the user experience.

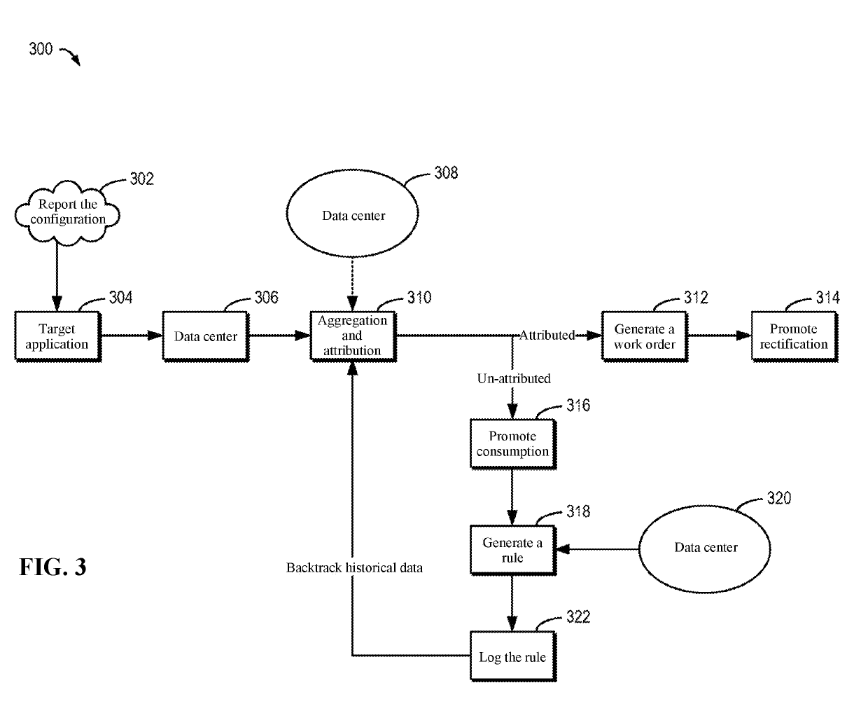

The schematic diagram of the example method for processing a log according to some embodiments of the present disclosure is described above in conjunction with FIG. 2, and the schematic diagram of the example of the flowchart for processing a log according to some embodiments of the present disclosure is described below in conjunction with FIG. 3. The example method may be performed by the computing device 102 in FIG. 1 or any suitable computing device.

As shown in FIG. 3, in an example 300, the configuration is first reported at block 302, and after receiving the instruction to report the configuration, the computing device 102 reports the configuration at a target application 304. In this process, the computing device 102 collects a plurality of original logs related to the runtime information, code debugging information, and stack information of the application.

Subsequently, the plurality of obtained original logs are pre-processed in a data center 306 to obtain a plurality of logs. The pre-processing step includes at least one of the following: format conversion, data cleaning, or time synchronization.

In addition, after the plurality of logs are obtained, the target log having the risky behavior is determined among the plurality of logs, and the contextual information including the target log is determined. Subsequently, the contextual information and a plurality of rules for the risky behavior in a rule base 308 are used to perform aggregation and attribution 310 on the target log to determine the risk issue of the target log. Additionally, the rule base 308 includes functions for the rules, such as editing rules and adding and deleting rules.

After the attribution of the target log is completed, a work order 312 is further generated. The user may further promote rectification 314 based on the generated work order to avoid the risk issue.

When the attribution of the target log is not completed, the computing device 102 continues to promote consumption at block 316, continues to promote the next process for the un-attributed target log, and then uses the rule editing function of a rule base 320 to generate a rule at block 318. After the rule for the target log is generated, the generated rule is logged at block 322.

In some embodiments, after the generated rule is logged, the rule base is updated, and the computing device 102 may further use the updated rule base to backtrack historical data. For example, a plurality of historical logs within a predetermined time period may be re-attributed.

Through this method, by utilizing the plurality of logs related to the runtime information, code debugging, and stack of the application, and in combination with the plurality of rules related to the plurality of logs, automated attribution of the risky behavior in the logs may be realized, and an analysis report for the risk issue may be further generated, which greatly reduces manpower consumption, improves the efficiency of processing the risky behavior in the logs, and improves the user experience. In addition, the updated rule base may also be used to attribute the un-attributed historical logs in the historical data, thereby improving the processing capability of the historical data.

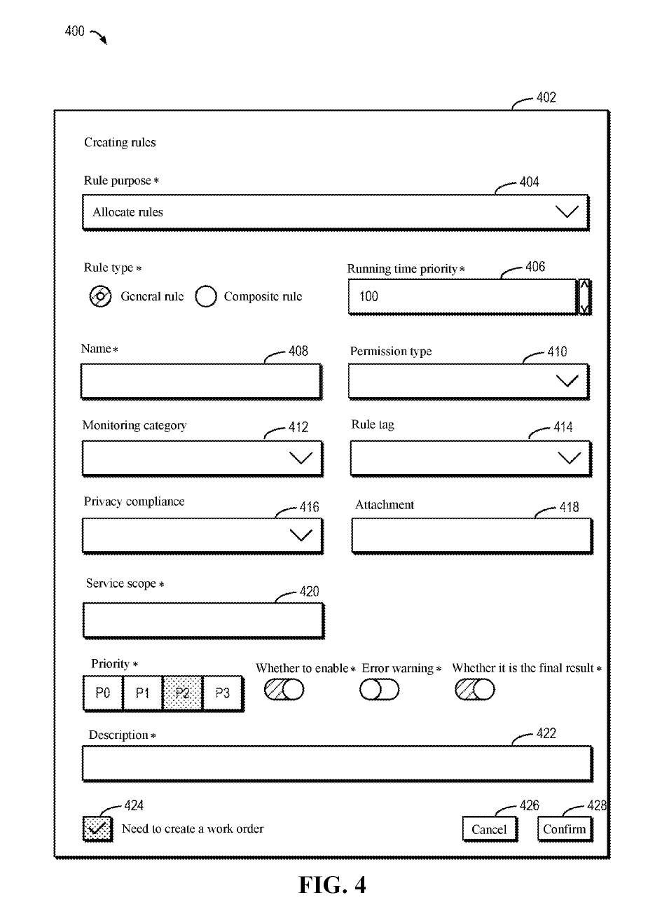

The schematic diagram of the example of the flowchart for processing a log according to some embodiments of the present disclosure is described above in conjunction with FIG. 3, and the schematic diagram of the example of creating rules for processing a log according to some embodiments of the present disclosure is described below in conjunction with FIG. 4.

As shown in FIG. 4, in an example 400, in combination with the previous example 300, the rule base includes the function of creating rules. The page for creating a rule 402 includes a rule purpose, and at block 404, the user may select the rule purpose. It should be understood that a plurality of different rule purposes are pre-stored in the rule purpose, and the user may select according to self-demand.

The page for creating the rule 402 further includes a running time priority 406 for the to-be-created rule, for example, the running time priority of 100 corresponds to the priority of P2. In one example, the higher the number of the running time priority, the higher the corresponding rule priority. It should be understood that the priority of the running time priority may be defined by the user, which is not limited in the present application.

The page for creating the rule 402 further includes information such as a name 408 of the to-be-created rule, a permission type 410, a monitoring scenario 412, a rule tag 414, privacy compliance 416, an attachment 418, and a service scope 420.

The permission type 410 may be a condition under which the to-be-created rule may be run, and for example, the permission type 410 may be information such as a region, a geographic location, and a time period in which the to-be-created rule may be run. The monitoring category 412 is secondary information corresponding to the permission type 410, and for example, the monitoring category 412 may be specific region information, a specific geographic location, specific short time information, or the like, in which the to-be-created rule may be run. The rule tag 414 may be defined by the user so that the user may more quickly and efficiently identify the use of the rule.

In some embodiments, the privacy compliance 416 indicates the level of privacy risk involved in the to-be-created rule. In one example, when the privacy risk level involved in the to-be-created rule is relatively high, the privacy compliance 416 option is enabled. It should be understood that the user may also determine whether to enable the privacy compliance 416, which is not limited in the present application.

The attachment 418 may be supplementary information for the to-be-created rule, for example, other information such as an association rule for the to-be-created rule, device information that may be used, and system information that may be used.

The service scope 420 includes the service scope for the target application to which the to-be-created rule may be applied. The user may further add a description of the to-be-created rule at block 422, so that other users may better understand the to-be-created rule.

After the basic information for the to-be-created rule is filled in, whether to select "need to create a work order" may be selected at block 424. After selection, after the to-be-created rule is created, whenever the rule comes into effect, a work order for the target log will be automatically generated, so that the user may promote subsequent rectification. Subsequently, it is confirmed at block 428 that the to-be-created rule is created. If the to-be-created rule is no longer needed, the creation of the rule may be cancelled at block 426.

Through this method, the rule base may be updated by creating rules, and the updated rule base may be used to attribute the target log and the historical logs, thereby improving the processing efficiency of historically accumulated data.

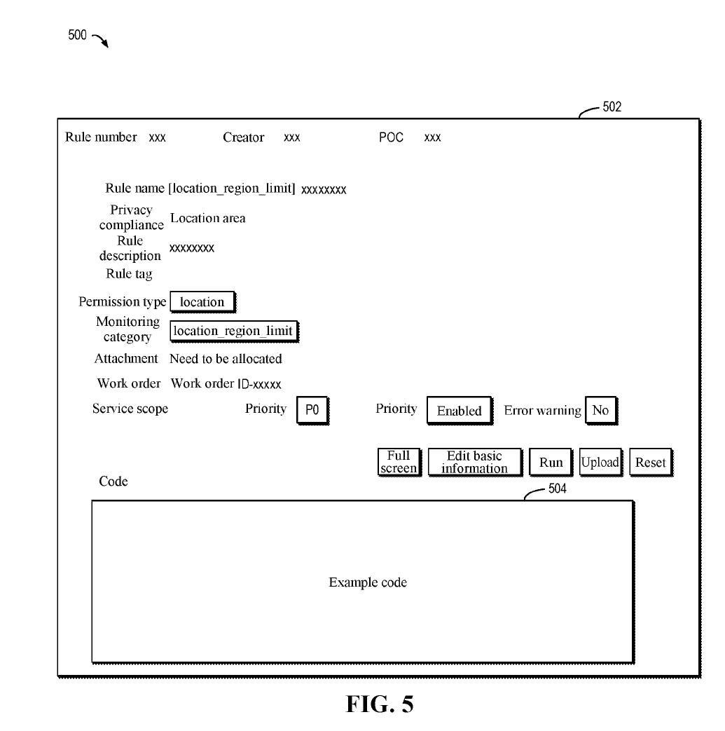

The schematic diagram of the example of creating rules for processing a log according to some embodiments of the present disclosure is described above in conjunction with FIG. 4, and the schematic diagram of the example of the rule detailed information for processing a log according to some embodiments of the present disclosure is described below in conjunction with FIG. 5.

As shown in FIG. 5, in an example 500, in combination with the previous example 400, the example 500 shows the rule detailed information of one of the plurality of rules.

At block 502, specific information for the rule are shown, including the rule number, the creator, etc., and information such as the rule name information "[location_region_limit] xxxxxxxx", privacy compliance information "location area", rule description "xxxxxxx", rule tag, permission type "location", detection scenario "location_region_limit", attachment "need to be allocated", work order "work order ID-xxxxx", and service scope are shown.

The priority of the current rule is also shown, for example, the priority of the current rule is P0, the priority has been enabled, and the error warning is not enabled.

In some embodiments, the rule further includes code information. Since some rules are suitable for large-scale log data processing, in addition to using regular expressions, the example code 504 in the rule may also be used to assist in processing large-scale logs, thereby improving the efficiency and accuracy of log processing.

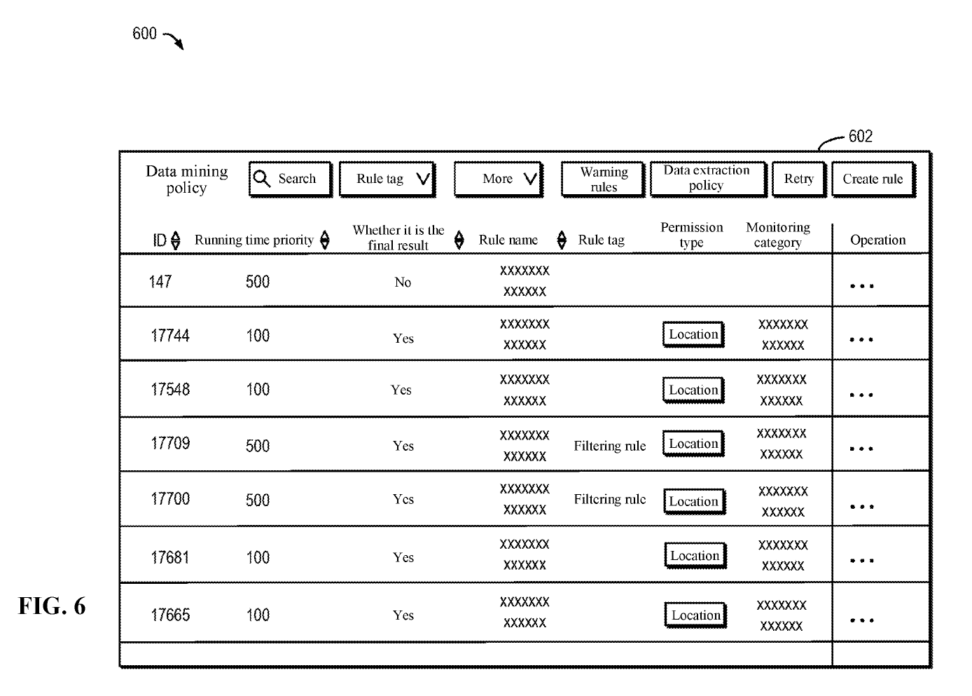

The schematic diagram of the example of the rule detailed information for processing a log according to some embodiments of the present disclosure is described above in conjunction with FIG. 5, and the schematic diagram of the example of the data mining policy for processing a log according to some embodiments of the present disclosure is described below in conjunction with FIG. 6.

As shown in FIG. 6, in an example 600, block 602 shows detailed information of the data mining policy. Block 602 shows the detailed information of the plurality of rules, and a search may be performed therein to search for and view a specific rule.

In addition, a specific rule tag may also be selected by pulling down the rule tag to view multiple rules with the same rule tag in batch. For each rule, operations may also be performed, for example, the rule may be deleted, or for another example, the rule may be edited.

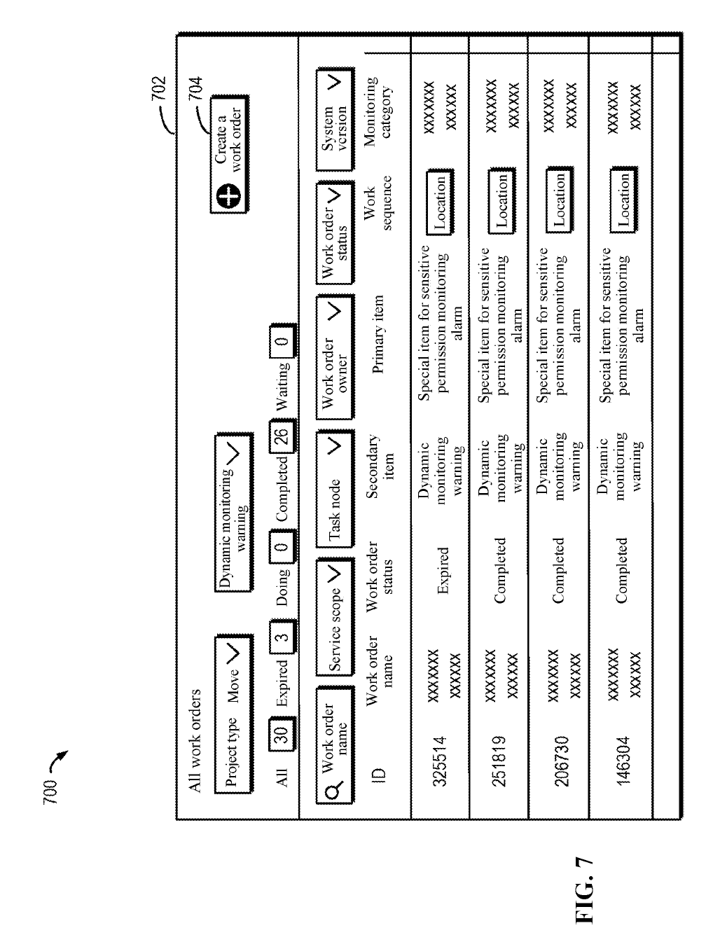

The schematic diagram of the example of the data mining policy for processing a log according to some embodiments of the present disclosure is described above in conjunction with FIG. 6, and the schematic diagram of the example of the information of all work orders for processing a log according to some embodiments of the present disclosure is described below in conjunction with FIG. 7.

As shown in FIG. 7, in an example 700, block 702 shows the information of all work orders.

Block 702 shows information such as the work order identification (ID), the work order name, the work order status (expired or completed), the secondary item (dynamic monitoring warning), the primary item (special item for sensitive permission monitoring alarm), the job sequence (location), and the monitoring category (xxxxx) for the work order.

In addition, a work order may also be created at block 704. After the attribution of the target log is completed, a work order for the target log may also be generated by manually creating the work order, and information required by the user may be added to the created work order to facilitate the subsequent promotion of rectification of the target log.

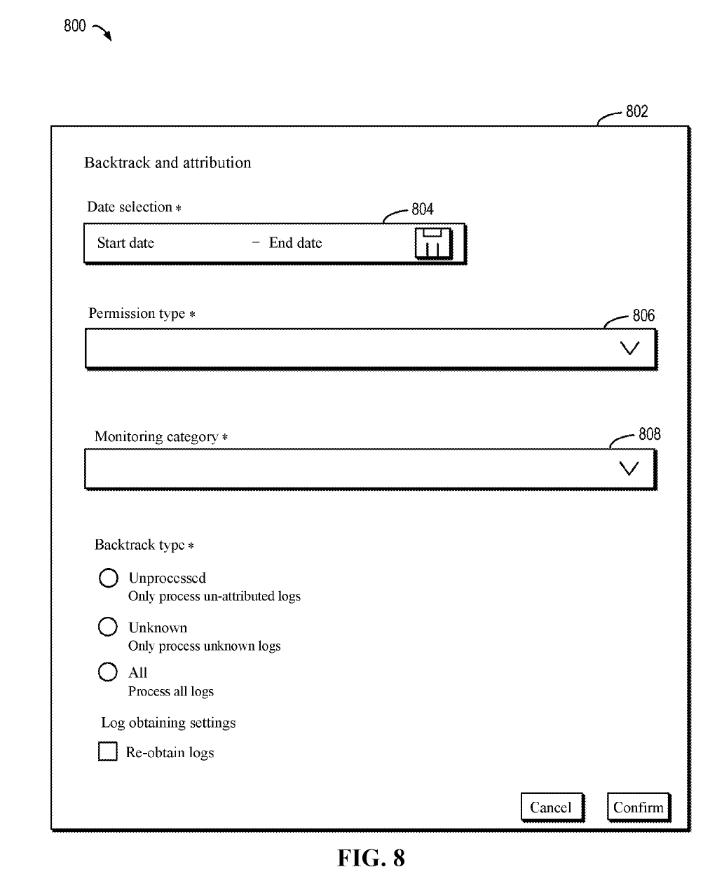

The schematic diagram of the example of the information of all work orders for processing a log according to some embodiments of the present disclosure is described above in conjunction with FIG. 7, and the schematic diagram of the example of re-attributing historical logs for processing a log according to some embodiments of the present disclosure is described below in conjunction with FIG. 8.

As shown in FIG. 8, in an example 800, block 802 shows a page for re-attributing historical logs. In block 802, the time period may be selected at block 804, for example, the start date and the end date of the logs that need to be re-attributed may be selected.

Subsequently, the permission type for re-attribution, for example, "location", is further selected at block 806, and the detection scenario, for example, "location_region_limit", is selected at block 808.

Additionally, the type of logs that need to be processed may also be selected in backtrack types. In one example, "unprocessed" may be selected, that is, only un-attributed logs are selected to be processed. In another example, "unknown" may be selected, that is, only unknown logs are processed. In yet another example, "all" may be selected, that is, all logs are processed.

In some embodiments, when the data in the database dedicated to storing the plurality of logs is cleared or the amount of data is insufficient, "re-obtain logs" may be selected, and then the computing device 102 re-obtains the plurality of logs.

After all information is confirmed, the computing device 102 performs backtrack and attribution to re-attribute the plurality of historical logs. An analysis result and a result report for the risky behavior in the plurality of historical logs are generated and presented to the user in a visual report.

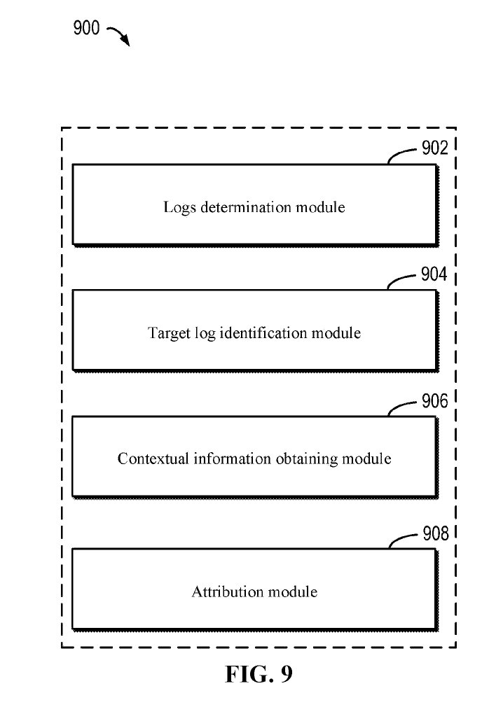

As shown in FIG. 9, the apparatus 900 includes logs determination module 902 configured to determine a plurality of logs related to running of an application; a target log identification module 904 configured to identify a target log having a risky behavior among the plurality of logs; a contextual information obtaining module 906 configured to obtain contextual information of the target log from the plurality of logs, the contextual information including the target log; and an attribution module 908 configured to attribute the target log to determine a risk issue of the target log based on a plurality of rules for the risky behavior and the contextual information.

In some embodiments, the contextual information obtaining module 906 includes: a predetermined number of logs obtaining module configured to select a predetermined number of logs including the target log from the plurality of logs; and a contextual information determination module configured to determine the predetermined number of logs as the contextual information.

In some embodiments, the attribution module 908 includes: a matching module configured to match the contextual information with contents of a rule among the plurality of rules; and a target log attribution module configured to, in response to a presence of a target rule in the plurality of rules that matches the contextual information, attribute the target log utilizing the target rule.

In some embodiments, the apparatus 900 further includes: a target rule generation module configured to, in response to an absence of a rule in the plurality of rules that matches the contextual information, generate a target rule for the risky behavior based on the contextual information; and a plurality of rules updating module configured to update the plurality of rules by adding the target rule into the plurality of rules.

In some embodiments, the apparatus 900 further includes: a plurality of historical logs determination module configured to determine a plurality of historical logs having risky behaviors within a predetermined time period; and a re-attribution module configured to re-attribute the plurality of historical logs utilizing the plurality of updated rules.

In some embodiments, the matching of the contextual information with the contents of a rule among the plurality of rules is implemented through at least one of the following: a regular expression or a program code.

In some embodiments, the plurality of rules include at least one of the following: an access control rule, a data leakage identification rule, or an abnormal behavior detection rule.

In some embodiments, the apparatus 900 further includes: a business credential generation module configured to, in response to the target log being attributed, generate a business credential for the target log; and a business logic adjustment module configured to adjust business logic related to the target log based on the business credential.

In some embodiments, the apparatus 900 further includes: an analysis result generation module configured to, in response to the target log being attributed, generate an analysis result of the risk issue corresponding to the target log based on the contextual information; and a result report generation module configured to generate a result report for the analysis result based on the analysis result.

In some embodiments, the logs determination module 902 includes: a plurality of initial logs obtaining module configured to obtain a plurality of initial logs related to runtime information, code debugging, and a stack of the application; and a pre-processing module configured to determine the plurality of logs by pre-processing the plurality of initial logs.

In some embodiments, the pre-processing includes at least one of the following: format conversion, data cleaning, or time synchronization.

In some embodiments, the apparatus 900 further includes: a plurality of rules creation module configured to create the plurality of rules for the plurality of logs based on the plurality of logs.

In some embodiments, a attribution of the target log is implemented using a message queue.

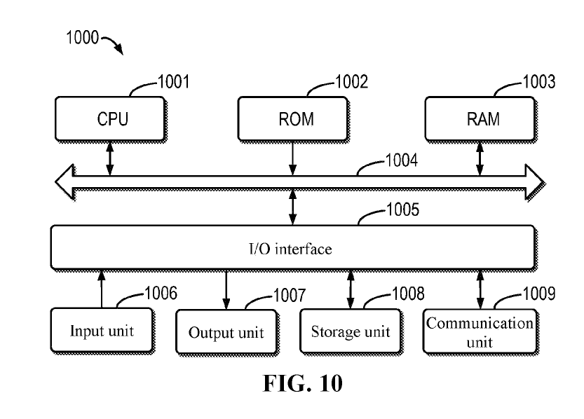

FIG. 10 shows a schematic block diagram of an example device 1000 that may be used to implement the embodiments of the present disclosure. The computing device 102 in FIG. 1 may be implemented using the device 1000. As shown in the figure, the device 1000 includes a central processing unit (CPU) 1001, which may perform various appropriate actions and processes based on computer program instructions stored in a read-only memory (ROM) 1002 or computer program instructions loaded from a storage unit 1008 into a random access memory (RAM) 1003. The RAM 1003 may also store various programs and data required for the operation of the device 1000. The CPU 1001, the ROM 1002, and the RAM 1003 are connected to each other through a bus 1004. An input/output (I/O) interface 1005 is also connected to the bus 1004.

Multiple components in the device 1000 are connected to the I/O interface 1005, and the components include: an input unit 1006, such as a keyboard, a mouse, etc.; an output unit 1007, such as various types of displays, speakers, etc.; the storage unit 1008, such as a magnetic disk, an optical disc, etc.; and a communication unit 1009, such as a network card, a modem, a wireless communication transceiver, etc. The communication unit 1009 allows the device 1000 to exchange information/data with other devices through a computer network such as Internet and/or various telecommunication networks.

The processes and processing described above, such as the method 200 and the examples 300 to 800, may be performed by the processing unit 1001. For example, in some embodiments, the method 200 and the examples 300 to 800 may be implemented as a computer software program, which is tangibly contained in a machine-readable medium, such as the storage unit 1008. In some embodiments, part or entirety of the computer program may be loaded and/or installed into the device 1000 via the ROM 1002 and/or the communication unit 1009. When the computer program is loaded into the RAM 1003 and executed by the CPU 1001, one or more actions of the example method 200 and the examples 300 to 800 described above may be executed.

The present disclosure may be a method, an apparatus, a system, and/or a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punch card or raised structures in a groove having instructions stored thereon, and any suitable combination of the above. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. The network adapter card or the network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a user computer, partly executed on a user computer, executed as an independent software package, partly executed on a user computer and partly executed on a remote computer, or entirely executed on a remote computer or a server. In the case of involving a remote computer, the remote computer may be connected to the user computer through any kind of network, including a local area network (LAN) or a wide area network (WAN), or may be connected to an external computer (for example, connected through Internet using an Internet service provider). In some embodiments, by utilizing the state information of the computer-readable program instructions to personalize and customize an electronic circuit, such as a programmable logic circuit, a field programmable gate array (FPGA) or a programmable logic array (PLA), the electronic circuit may execute the computer-readable program instructions, thereby implementing various aspects of the present disclosure.

Various aspects of the present disclosure are described herein with reference to the flowcharts and/or block diagrams of the method, the apparatus (system), and the computer program product according to the embodiments of the present disclosure. It should be understood that each block of the flowcharts and/or block diagrams, and combinations of blocks in the flowcharts and/or block diagrams, may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing a function/action specified in one or more blocks in the flowcharts and/or block diagrams. These computer-readable program instructions may also be stored in a computer-readable storage medium, and these instructions cause a computer, a programmable data processing apparatus, and/or other devices to work in a specific manner, such that the computer-readable medium storing the instructions includes a manufactured product, which includes instructions for implementing various aspects of the function/action specified in one or more blocks in the flowcharts and/or block diagrams.

The computer-readable program instructions may also be loaded onto a computer, another programmable data processing apparatus, or another device, so that a series of operations and steps are performed on the computer, the another programmable data processing apparatus, or the another device to produce a computer-implemented process, such that the instructions executed on the computer, the another programmable data processing apparatus, or the another device implement the function/action specified in one or more blocks in the flowcharts and/or block diagrams.

The flowcharts and block diagrams in the drawings show the possibly implemented architectures, functions, and operations of the system, the method, and the computer program product according to multiple embodiments of the present disclosure. In this regard, each block in the flowchart or block diagram may represent a module, a program segment, or part of instructions, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform specified functions or actions, or may be implemented by a combination of special-purpose hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the actual application or technical improvement to the market, or to enable other those of ordinary skill in the art to understand the embodiments disclosed herein.

We claim:

1. A method for processing a log, comprising:
determining a plurality of logs related to running of an application;
identifying a target log having a risky behavior among the plurality of logs;
obtaining contextual information of the target log from the plurality of logs, the contextual information comprising the target log; and
attributing the target log to determine a risk issue of the target log based on a plurality of rules for the risky behavior and the contextual information.

2. The method of claim 1, wherein obtaining the contextual information of the target log from the plurality of logs comprises:
selecting a predetermined number of logs comprising the target log from the plurality of logs; and
determining the predetermined number of logs as the contextual information.

3. The method of claim 1, wherein attributing the target log to determine the risk issue of the target log comprises:
matching the contextual information with contents of a rule among the plurality of rules; and
in response to a presence of a target rule in the plurality of rules that matches the contextual information, attributing the target log utilizing the target rule.

4. The method of claim 3, further comprising:
in response to an absence of a rule in the plurality of rules that matches the contextual information, generating a target rule for the risky behavior based on the contextual information; and
updating the plurality of rules by adding the target rule into the plurality of rules.

5. The method of claim 4, further comprising:
determining a plurality of historical logs having risky behaviors within a predetermined time period; and
re-attributing the plurality of historical logs utilizing the plurality of updated rules.

6. The method of claim 3, wherein matching the contextual information with the contents of a rule among the plurality of rules is implemented through at least one of the following:
a regular expression or a program code.

7. The method of claim 1, wherein the plurality of rules comprise at least one of the following:
an access control rule, a data leakage identification rule, or an abnormal behavior detection rule.

8. The method of claim 1, further comprising:
in response to the target log being attributed, generating a business credential for the target log; and
adjusting business logic related to the target log based on the business credential.

9. The method of claim 1, further comprising:
in response to the target log being attributed, generating an analysis result of the risk issue corresponding to the target log based on the contextual information; and
generating a result report for the analysis result based on the analysis result.

10. The method of claim 1, wherein determining the plurality of logs related to the running of the application comprises:
obtaining a plurality of initial logs related to runtime information, code debugging, and a stack of the application; and
determining the plurality of logs by pre-processing the plurality of initial logs.

11. The method of claim 10, wherein the pre-processing comprises at least one of the following:
format conversion, data cleaning, or time synchronization.

12. The method of claim 9, further comprising:
creating the plurality of rules for the plurality of logs based on the plurality of logs.

13. The method of claim 1, wherein a re-attribution of the target log is implemented using a message queue.

14. An electronic device, comprising:
at least one processor; and
a memory device for storing at least one program, wherein the at least one program, when executed by the at least one processor, causes the at least one processor to:
determine a plurality of logs related to running of an application;
identify a target log having a risky behavior among the plurality of logs;
obtain contextual information of the target log from the plurality of logs, the contextual information comprising the target log; and
attribute the target log to determine a risk issue of the target log based on a plurality of rules for the risky behavior and the contextual information.

15. The electronic device of claim 14, wherein the at least one program further causes the at least one processor to:
select a predetermined number of logs comprising the target log from the plurality of logs; and
determine the predetermined number of logs as the contextual information.

16. The electronic device of claim 14, wherein the at least one program further causes the at least one processor to:
match the contextual information with contents of a rule among the plurality of rules; and
in response to a presence of a target rule in the plurality of rules that matches the contextual information, attribute the target log utilizing the target rule.

17. The electronic device of claim 16, wherein the at least one program further causes the at least one processor to:
in response to an absence of a rule in the plurality of rules that matches the contextual information, generate a target rule for the risky behavior based on the contextual information; and
update the plurality of rules by adding the target rule into the plurality of rules.

18. The electronic device of claim 17, wherein the at least one program further causes the at least one processor to:
determine a plurality of historical logs having risky behaviors within a predetermined time period; and
re-attribute the plurality of historical logs utilizing the plurality of updated rules.

19. The electronic device of claim 14, wherein the at least one program further causes the at least one processor to:
in response to the target log being attributed, generate a business credential for the target log; and
adjust business logic related to the target log based on the business credential.

20. A non-transitory computer-readable storage medium having a computer program stored thereon, wherein the computer program, when executed by a processor, causes the processor to:
determine a plurality of logs related to running of an application;
identify a target log having a risky behavior among the plurality of logs;
obtain contextual information of the target log from the plurality of logs, the contextual information comprising the target log; and
attribute the target log to determine a risk issue of the target log based on a plurality of rules for the risky behavior and the contextual information.
